(19) United States
(12) Patent Application Publication
(10) Pub. No.: US 2006/0046753 A1
(43) Pub. Date: Mar. 2, 2006

(54) Systems and methods for object identification

(76) Inventor: Robert C. Lovell JR., Leesburg, VA (US)

Correspondence Address: Lawrence D. Eisen;Pillsbury Winthrop Shaw Pittman LLP, 1650 Tysons Boulevard, McLean, VA, 22102, US

(21) Appl. No.: 11/211,617

(22) Filed: Aug. 26, 2005

Related U.S. Application Data
(60) Provisional application No. 60/604,436, filed on Aug. 26, 2004.

(51) Int. Cl. H04Q 7/20

(52) U.S. Cl. 455/466; 455/412.1

(57) ABSTRACT

Methods and systems for providing information services over a communications network include steps and structure for receiving an inquiry message from a mobile subscriber relating to an information service that is desired by the mobile subscriber, routing the inquiry message for processing, performing one or more activities in accordance with the requested information service, and returning a response message to the mobile subscriber.

This application claims the benefit of U.S. Provisional Patent Application No. 60/604,436, filed on Aug. 26, 2004, which is herein incorporated by reference in its entirety.

### BACKGROUND

1. Field of the Invention

The present disclosure relates generally to telecommunications services. More particularly, the present disclosure relates to a service capable of combining several different technologies to offer a customer the ability to submit an inquiry to an Inter-Carrier Vendor (ICV), or other similarly situated entity, to receive additional information pertinent to the inquiry. For example, a user may send a Multimedia Message Service (MMS) message from a communication device, such as a camera phone, containing a picture of an unknown object and may receive information back from the network to the communication device providing more detail or information regarding the content of the picture.

2. Background of the Invention

While the ‘wireless revolution’ continues to march forward it carries with it a range of untapped, or under-exploited, potentials. As the various technological (e.g., ubiquitous cross-carrier interoperability), social (e.g., user or subscriber inertia), etc. impediments are breached, wireless data services, including, for example amongst others, Short Message Service (SMS) and MMS, continue to grow and continue to provide significant revenue opportunities to wireless carriers. To sustain that growth a continual stream of new ‘singular’ wireless data products and services is required.

As with premium SMS, which is increasingly dependent on third parties for everything from ring tones and icons to mass voting for contests and reality shows, the growing adoption of MMS will create a need for corresponding services. The InphoIdentify system described herein, or a similarly-implemented system, represents just such a service.

### BRIEF SUMMARY OF THE INVENTION

According to one exemplary aspect, the present invention relates to a method for providing an information service, comprising receiving an inquiry message from a mobile subscriber relating to an information service that is desired by the mobile subscriber, routing the inquiry message for processing, performing one or more activities in accordance with the requested information service, and returning a response message to the mobile subscriber.

According to another exemplary aspect of the present invention, a system is disclosed for providing information services. The system includes a mobile wireless device, a provider network, an inter-carrier vendor network, and an information service. The system is operable to route an inquiry message relating to an information service that is desired by the user of the mobile wireless device from the mobile wireless device through the provider network to the information service via the inter-carrier vendor network resulting in an appropriate set of processing activities in accordance with the requested information service and the dispatch of a response message to the mobile wireless device.

These and other features of embodiments of the present invention will be more fully explained below in conjunction with the drawings.

### BRIEF DESCRIPTION OF THE DRAWINGS

FIG. 1 is a diagrammatic presentation of an exemplary user experience that may be realized through the instant invention.

FIG. 2 is a standards-based Multimedia Message Service (MMS) reference architecture.

### DETAILED DESCRIPTION OF THE INVENTION

The InphoIdentify (II) service leverages the recent confluence of several different technologies, capabilities, etc. (including, inter alia, the Multimedia Message Service [MMS], the role of a full-featured messaging Inter-Carrier Vendor [ICV], robust billing capabilities, etc.) to provide wireless carriers (and, by extension, those carriers' individual Mobile Subscribers [MSs]) new and exciting services.

Consider the opportunities/advantages, etc. that arise from the hypothetical InphoIdentify user experience described below.

In step 1 an MS of a Wireless Carrier (WC) encounters an object of interest—e.g., a natural landmark, a man-made monument, a painting, an animal or a flower in nature, a coin, etc. In step 2, the MS captures an image of the item on his/her camera-equipped mobile telephone. In step 3, the MS formulates an MMS message to send the captured image to an address—e.g., identify@inphomatch.com—of which the MS was previously made aware. In step 4, the MS′ WC receives the MMS message, examines the destination address, identifies the destination address as residing outside of the WC's network, and passes the message along to its (i.e., the WC's) Inter-Carrier Vendor (ICV).

In step 5, the ICV receives the MMS message and performs various (flexible, extensible, and dynamically configurable) processing actions that place key data elements from the message (including, inter alia, the source/from address, the destination/to address, the image, etc.) in a, preferably, neutral, protocol and technology independent, intra-ICV format. In step 6, the ICV examines the destination address of the message and determines that the message should be routed to the InphoIdentify (II) service for processing.

In step 7, the II service employs one or more image identification techniques or capabilities (which will be described in further detail below) to identify the image.

In step 8, the ICV generates a reply/response SMS or MMS message containing a description of the object and dispatches the message to the MS′ WC.

In step 9, the MS′ WC receives the reply/response message from the ICV, examines the destination address, identifies the destination address as residing inside of the WC's network, and delivers the reply/response message to the MS. In step 10, the MS receives the reply/response message on his/her mobile telephone.

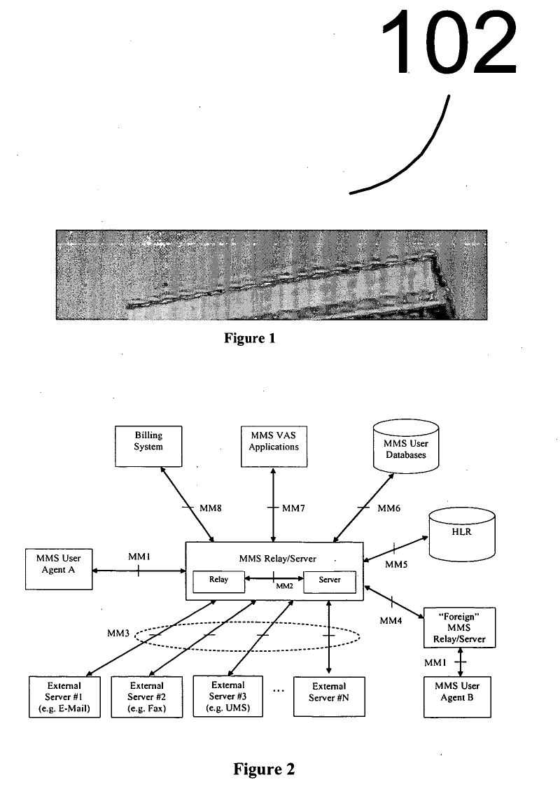

The user experience that was just described may be illustrated through the diagram depicted in FIG. 1. Event A 106 captures Steps 1, 2, and 3 from the user experience narrative that was presented above. An MS of a Wireless Carrier (WC) 108 encounters an object of interest 102—e.g., a natural landmark, a man-made monument, a painting, an animal or a flower in nature, a coin, etc. The MS captures an image of the item on his/her camera-equipped mobile telephone 104. The MS formulates an MMS message to send the captured image to an address—e.g., identify@inphomatch.com—which the MS was previously made aware of.

Event B 110 captures Step 4 from the user experience narrative. The MS′ WC receives the MMS message, examines the destination address, identifies the destination address as residing outside of the WC's network, and passes the message along to its (i.e., the WC's) ICV 112.

Event C 118 captures Steps 5 and 6 from the user experience narrative. The ICV 112 receives the MMS message and performs various (flexible, extensible, and dynamically configurable) processing actions that place key data elements from the message (including, inter alia, the source/from address, the destination/to address, the image, etc.) in a, preferably, neutral, protocol and technology independent, intra-ICV format. The ICV 112 examines the destination address of the message and determines that the message should be routed to the InphoIdentify (II) service 116 for processing.

Event D 120 captures Step 7 from the user experience narrative. The II service 116 employs one or more image identification techniques or capabilities (explained in more detail below) to identify the image.

Event E 122 captures Step 8 from the user experience narrative. The ICV 112 generates a reply/response SMS or MMS message containing a description of the object and dispatches the message to the MS′ WC 108.

Event F 124 captures Steps 9 and 10 from the user experience narrative. The MS′ WC receives the reply/response message from the ICV, examines the destination address, identifies the destination address as residing inside of the WC's network, and delivers the reply/response message to the MS. The MS receives the reply/response message on his/her mobile telephone 104.

It is important to note that the basic user experience that was described in the narrative and illustrated in FIG. 1 is exemplary only. It will be readily apparent to one of ordinary skill in the relevant art that numerous alternatives to the presented scenario are easily possible. By way of example, possible non-limiting alternative examples are listed below.

Service Registration. As described in Step 3 of the user experience narrative, the MS formulates an MMS message to send a captured image to an address—e.g., identify@inhphomatch.com—of which the MS was previously made aware. The address may have been provided to the MS by the MS′ WC as part of a service package or as part of an advertising campaign. Alternatively, the MS may have been directed (by following, for example, information from the MS′ WC, the MS′ ICV, etc.) to a Web site where the MS received an address and optionally completed a service registration process.

Routing. As described in Step 4 of the user experience narrative, the MS′ WC receives the MMS message, examines the destination address, identifies the destination address as residing outside of the WC's network, and passes the message along to its (i.e., the WC's) ICV.

The various publicly available MMS definitional standards describe, inter alia, the routing of MMS messages. One of the publicly-available MMS definitional standards is the TS 23.140 specification from the Third Generation Partnership Project (3GPP). That specification presents an MMS Reference Architecture that is exemplified in FIG. 2 and describes each of the identified interfaces:

| Interface | Description |
|---|---|
| MM1 | The interface between an MMS User Agent and an MMS |
| | Relay/Server |
| MM2 | The interface between an MMS Relay and an MMS Server |
| MM3 | The interface between an MMS Relay/Server and external |
| | (legacy) systems |
| MM4 | The interface between two MMS Relay/Server instances |
| MM5 | The interface between an MMS Relay/Server and a Home |
| | Location Register (HLR) |
| MM6 | The interface between an MMS Relay/Server and an MMS |
| | User Database |
| MM7 | The interface between an MMS Relay/Server and an MMS |
| | VAS Application |
| MM8 | The interface between an MMS Relay/Server and a billing |
| | system |

It will be readily apparent to one of ordinary skill in the relevant art that the conveyance of an MMS message from a MS′ WC to an ICV may be accomplished through any number of mechanisms, including inter alia an MM1- or an MM4-based mechanism.

Transcoding. As described in Step 5 of the user experience narrative, the ICV receives an MMS message and performs various (flexible, extensible, and dynamically configurable) processing actions that place key data elements from the message (including, inter alia, the source/from address, the destination/to address, the image, etc.) in a, preferably, neutral, protocol and technology independent, intra-ICV format. A description of the various ICV processing actions may be found under pending U.S. application Ser. No. 10/426,662 entitled “A INTERMEDIARY NETWORK SYSTEM AND METHOD FOR FACILITATING MESSAGE EXCHANGE BETWEEN WIRELESS NETWORKS,” which is incorporated herein by reference. One of the processing actions is transcoding. For a description of the importance, and in some cases the necessity, of transcoding, please see pending U.S. patent application Ser. No. 10/706,975 entitled “SYSTEM AND METHOD FOR PROVIDING CONFIGURABLE, DYNAMIC MULTIMEDIA MESSAGE SERVICE PRE-TRANSCODING,” which is incorporated herein by reference.

Image Identification. As described in Step 7 of the user experience narrative, the InphoIdentify service 116 may employ one or more image identification techniques or capabilities to identify a presented image. The catalog of identification techniques or capabilities may include, inter alia, image or pattern recognition software, human intervention (e.g., where the presented image is displayed to a human operator and the human operator identifies the image), external third-party services/solutions, and various combinations (e.g., where image/pattern recognition software performs an initial match [possibly assigning an attendant match confidence factor ‘score’ or ‘grade’] and a human operator subsequently reviews and/or refines the match [possibly only for those matches whose match confidence factor falls below some pre-configured, but dynamically administrable, threshold level]).

The array of identification techniques and capabilities that are applied to a specific image may be dynamically identified based on, inter alia, the existence of a subscription service (that was previously established by the MS′ WC for all of that WC's MSs and was previously established by the MS during a registration process, etc.) that carries with it a specified Quality of Service (QoS) level. For example, if during a service registration process an MS elected to receive a ‘higher’ level of QoS (i.e., a better quality, caliber, etc. of image identification) then human intervention might automatically follow any automated image matching operations.

Response Message. As described in Step 8 of the user experience narrative, the ICV generates a reply/response message containing a description of the object.

The reply/response message may take the form of a Short Message Service (SMS) message (containing, for example, a brief written description of the object) or a MMS message (containing, for example, a brief written description of the object along with alternate views/images of the object).

The reply/response message may optionally contain various value-add elements. Such elements may include, inter alia:

Explanatory Material. Further, more elaborative, information about the object may be provided. The information may originate from various free (publicly available) sources and various fee-based sources (to whom a payment, on a subscription basis or on a per-event/per-lookup basis, may be owed).

Web Addresses. One or more Uniform Resource Locators (URLs) or Web addresses under which further information about the object may be retrieved.

Advertising. Product, brand, etc. text and/or image(s) from various external sponsors and advertisers may be incorporated. Text and/or images may be included universally (either statically [the same material is included in each reply/response message] or randomly [the material that is included in a reply/response message is randomly selected from a pool of available material]) or may be context sensitive (where the included material is in some way related to the object).

In addition to sending information to the MS's mobile communication device, the system may also be linked to other communication devices, for example, an MS's e-mail account so that such information may be retrieved from the MS's computer. Viewing from a computer rather than a mobile communication device may allow for more robust content to be more easily explored by the MS in relation to the object to be identified.

It will be readily apparent to one of ordinary skill in the relevant art that the catalog of value-add elements that was just presented is exemplary only; numerous other elements may be easily added.

For example, if during a service registration process an MS elected to pay to receive a ‘higher’ level of QoS then value-add elements may be inserted into reply/response messages that are addressed to the MS.

Value-add elements may be retrieved from an internal data store or may be retrieved from one or more external entities.

Financial. Various of the elements of the InphoIdentify service that have been described above may rely on a financial capability. For example, MS service registration, image identification, response message generation, etc. Such a financial capability may include, inter alia:

Billing. The present invention may preferably include the real-time ability to cause a detail line-item charge to appear on an MS′ telephone bill (through the MS′ WC) for a rendered service. Mechanics, logistics, complexities, etc. of such an exemplary capability may be found under pending U.S. patent application Ser. No. 10/837,695 entitled “SYSTEM AND METHOD FOR BILLING AUGMENTATION,” which is incorporated herein by reference.

Revenue Collection and/or Distribution. The present invention may also provide, for example, the acceptance/collection, processing, and potential distribution of funds based on flexible, extensible, and dynamically configurable parameters may be possible. Additionally, the ability to comprehensively report on amounts collected and distributed ‘up’ and ‘down’ a chain of actors/entities could be added as a functionality.

Disbursement. Further still, the present invention may provide, for example, the disbursement of fees to external third-party information and/or service providers based on various models—subscription (annual, quarterly, monthly, etc.), event-based (with flat pricing, with tiered or threshold pricing, etc.), or other models.

It is important to note that the specific object identification features and functions that were just described are representative only. It will be readily apparent to one of ordinary skill in the relevant art that numerous other features/functions are easily possible within the scope of the present invention.

The following list defines acronyms as used in this disclosure.

| Term | Meaning |
|---|---|
| ICV | Inter-Carrier Vendor |
| II | InphoIdentify |
| MMS | Multimedia Message Service |
| MS | Mobile Subscriber |
| SMS | Short Message Service |
| 3GPP | Third Generation Partnership Project |
| URL | Uniform Resource Locator |
| WC | Wireless Carrier |

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for providing information services over a communications network, comprising:
receiving an inquiry message from a mobile subscriber;
routing the inquiry message for processing;
performing one or more identification techniques; and
returning a response message to said mobile subscriber.

2. The method of claim 1, wherein the inquiry message comprises an Multimedia Message Service (MMS) message.

3. The method of claim 1, wherein the step of receiving is performed by at least one of a wireless carrier, an inter-carrier vendor, a gateway and an identification service.

4. The method of claim 1, wherein the identification techniques employ at least one automated facility.

5. The method of claim 4, wherein the automated facility performs image or pattern recognition.

6. The method of claim 1, wherein the identification techniques employ at least one manually-applied facility.

7. The method of claim 1, wherein the identification techniques are dynamically determined based on quality-of-service levels.

8. The method of claim 1, wherein the response message is an MMS message.

9. The method of claim 1, wherein the response message is an SMS message.

10. The method of claim 9, wherein the response message contains explanatory text.

11. The method of claim 9, wherein the response message contains a URL.

12. The method of claim 9, wherein the response message contains an advertisement.

13. The method of claim 1, further comprising capturing financial information.

14. The method of claim 1, further comprising capturing quality-of-service target information.

15. The method of claim 1, wherein the processing includes generating a line-item charge for inclusion on the mobile subscriber's telephone bill.

16. The method of claim 1, wherein the processing includes at least one of collecting funds and distributing funds.

17. A method for providing information services, comprising:
receiving a message, initiated by a mobile subscriber, that includes information about which an inquiry is being made;
analyzing the information by forwarding at least one of the message and the information to an appropriate analyzing entity, the analyzing entity being at least able to identify and associate identity data with the information;
generating a response message that includes the identity data; and
addressing the response message such that the response message can be routed to the mobile subscriber.

18. The method of claim 17, wherein the information comprises an image and the step of analyzing comprises at least one of automatic pattern recognition and manual analysis.

19. The method of claim 18, wherein the step of analyzing comprises determining a level of quality of service to apply to the message and performing analysis steps commensurate with said level of quality of service.

20. A system for providing information services over a communications network, comprising:
an inter-carrier vendor network that is in communication with at least one provider network and its associated mobile wireless subscribers via their respective mobile wireless devices; and
an information service,
the system being operable to route an inquiry message relating to an information service that is desired by one of the mobile subscribers from said mobile wireless device through the provider network to the information service via the inter-carrier vendor network resulting in an appropriate set of processing activities in accordance with said requested information service and the dispatch of a response message to said mobile wireless device.
